(19) United States
(12) Patent Application Publication
(10) Pub. No.: US 2013/0155552 A1
(43) Pub. Date: Jun. 20, 2013

(54) MOTOR DRIVE DEVICE

(71) Applicants: Kenji Sugiura, Osaka (JP); Hirokazu Yamasaki, Osaka (JP); Yasushi Kato, Kyoto (JP); Toshiki Tsubouchi, Osaka (JP); Tomoya Hosokawa, Osaka (JP)

(72) Inventors: Kenji Sugiura, Osaka (JP); Hirokazu Yamasaki, Osaka (JP); Yasushi Kato, Kyoto (JP); Toshiki Tsubouchi, Osaka (JP); Tomoya Hosokawa, Osaka (JP)

(73) Assignee: PANASONIC CORPORATION, Kadoma-shi, Osaka (JP)

(21) Appl. No.: 13/818,598

(22) PCT Filed: Sep. 6, 2011
(86) PCT No.: PCT/JP2011/004976

§ 371 Date: Feb. 22, 2013

(30) Foreign Application Priority Data
Sep. 15, 2010 (JP) 2010-206302

(51) Int. Cl. H02H 1/00

(52) U.S. Cl. CPC H02H 1/0007
USPC 361/23

(57) ABSTRACT

A motor drive device according to the present invention includes a motor having a rotor and a drive coil, a rotor position detector, a speed detector that converts position information into speed information, a direction detector that converts the position information into rotating direction information, and a drive unit that drives the motor. When any one of a case where a pulse of a rotor position detector signal is not inputted to the speed detector and another case where a change of rotating direction of the motor is detected by the direction detector in a state in which the rotor repeats a forward rotation and a backward rotation in a condition of the rotor is locked.

### TECHNICAL FIELD

The present invention relates to a method and configuration that detect a locking state of a motor and a motor drive device that performs locking protection of the motor.

### BACKGROUND ART

A conventional motor drive device performs locking protection of a motor by using the following method and configuration that detect locking of the motor and a conventional detecting method. In this case, the conventional motor drive device includes a rotor, a drive coil, a rotor position detector, a speed detector that converts position information into speed information, and a drive unit that drives a motor.

Although a drive command for the motor exhibits an ON state, when speed information of the motor converted with the speed detector becomes zero (L), it is detected that the motor is locked. When the locked motor is detected, the drive unit protects the motor by turning off a drive output to the motor.

That is, the conventional motor drive device has a rotation sensor that outputs a pulse signal each time the motor rotates a predetermined number of times. There is disclosed a method of detecting that the motor is locked when the pulse signal from the rotation sensor is not outputted within a preset locking detection time (refer to PTL 1, for example).

A method of detecting a locking state of a motor in the conventional motor drive device will be concretely described below with reference to FIG. 4 and FIG. 5.

FIG. 4 is a diagram for explaining a configuration that detects a locking state of a motor to protect the motor in the conventional motor drive device.

As shown in FIG. 4, the conventional motor drive device includes rotor 1, drive coil 2, rotor position detector 3, speed detector 4, and drive unit 7. Rotor position detector 3 includes a rotation sensor such as a hall IC. Speed detector 4 converts position information of rotor 1 detected by rotor position detector 3 into speed information. Drive unit 7 receives drive command 6 for the motor and outputs a drive output to the motor. The motor is rotationally driven by the drive output outputted from drive unit 7.

An operation of a conventional motor drive device will be described below with reference to FIG. 5.

FIG. 5 is a diagram for explaining an operation of detecting a locking state of a motor to protect the motor in the conventional motor drive device.

In this case, as shown in FIG. 5, as the rotor position, a moving distance from a start position corresponds to the ordinate axis, and time corresponds to the abscissa axis. In an A section, when rotor 1 rotates once, a rotor position changes at an inclination in proportion to a speed (moving distance/time) from the start position and returns to the start position again.

Each time rotor 1 rotates once, rotor position detector 3 outputs rotor position detector signal (U) as one pulse. At this time, speed detector 4 measures time t1 that is a time interval from a rising edge to the next rising edge of the pulse of rotor position detector signal (U) or a time interval from a falling edge to the next falling edge to make it possible to measure speed information H and a rotating speed of rotor 1.

In a B section shown in FIG. 5, when rotor 1 is locked during rotation, in a time interval from a rising edge to the next rising edge or from a falling edge to the next falling edge of the pulse of rotor position detector signal (U) in a period of time of locking detection time t2, rotor position detector signal (U) is not inputted. In this case, the speed information is set to zero (L), and it is determined that a rotating state of rotor 1 is a locking state. The drive output of drive unit 7 that drives the motor is turned off to perform locking protection of the motor.

At this time, in general, when the rotation of rotor 1 is in a locking state, it is determined that a drive current for rotating the motor lacks, and drive unit 7 intends to continue a state in which the motor is driven by the maximum current. In this manner, the motor abnormally generates heat, and may be broken down. However, a drive output applied to the motor is turned off by the locking protection of the motor to make it possible to prevent the motor from being broken down.

The conventional method of protecting the locking state of the motor is effective when rotor 1 rotates in a predetermined direction.

However, as indicated by a C section in FIG. 5, an abnormal state occurs in which, depending on the types of external loads driven by the motor, a difference in the hardness of foreign matter, and a difference in elastic forces, a rotating direction repeatedly changes into a forward (+) direction or a backward (−) direction without being constant. More specifically, such a case includes a case where, when a motor is used in a blowing fan installed outside, due to an elastic force of a branch or the like that is in contact with, for example, a fan serving as an external load, the fan instantaneously rotates in a backward direction to hinder constant rotation.

In this case, speed detector 4 measures time t3 that is a time interval from a rising edge to the next rising edge of the pulse of rotor position detector signal (U) or a time interval from a falling edge to the next falling edge and determines it as speed information H.

More specifically, it is determined that rotor 1 of the motor rotates. As a result, it cannot be recognized that rotor 1 of the motor is in a locking state, drive unit 7 does not turn off a drive output supplied to the motor.

Thus, although rotor 1 of the motor does not normally rotate in a predetermined direction, the abnormal motor cannot be detected. For this reason, drive unit 7 intermits a drive output that intends to rotate the motor with the maximum current and continuously outputs the drive output to the motor. As a result, the motor abnormally generates heat, and is disadvantageously broken out. PLT1: Unexamined Japanese Patent Publication No. 2009-285805

### SUMMARY OF THE INVENTION

A motor drive device according to the present invention includes a motor having a rotor and a drive coil, a rotor position detector that detects position information of the rotor, a speed detector that converts the position information into speed information, a direction detector that converts the position information into rotating direction information, and a drive unit that drives the motor. In a state in which a drive command is inputted to the drive unit and the motor is driven, the motor drive device determines that the motor is locked and turns off a drive output of the drive unit upon detection of any one of a case where a rotor position detector signal is not inputted from the rotor position detector into the speed detector and another case where a change of rotating direction of the motor is detected by the direction detector during measurement of a time interval between rising edges or between falling edges of the pulse of the rotor position detector signal from the rotor position detector in a state in which the rotor repeats a forward rotation and a backward rotation in a condition that the rotor is locked.

In this manner, a locking state is determined even though the motor is a locking state in which the motor repeats a forward rotation and a backward rotation, locking protection of the motor can be provided. As a result, the motor can be prevented from being broken down, and a motor drive device having excellent reliability and excellent safety can be realized.

### BRIEF DESCRIPTION OF THE DRAWINGS

FIG. 1 is a diagram for explaining a configuration that detects a locking state of a motor to protect the motor in a motor drive device according to an exemplary embodiment of the present invention.

FIG. 2 is a diagram for explaining an operation of detecting a locking state of a motor to protect the motor in the motor drive device according to the exemplary embodiment of the present invention.

FIG. 3 is a diagram showing logics of rotor position detector signals (U), (V), and (W) when the motor rotates in a forward direction in the motor drive device.

FIG. 4 is a diagram for explaining a configuration that detects a locking state of a motor to protect the motor in a conventional motor drive device.

FIG. 5 is a diagram for explaining an operation of detecting a locking state of the motor to protect the motor in the conventional motor drive device.

### DETAILED DESCRIPTION OF THE PREFERRED EMBODIMENTS

A motor drive device according to an exemplary embodiment of the present invention will be described below with reference to the accompanying drawings. The following explanation will be made such that the same reference numerals denote the same or corresponding constituent elements. The present invention is not limited to the exemplary embodiment.

### Exemplary Embodiment

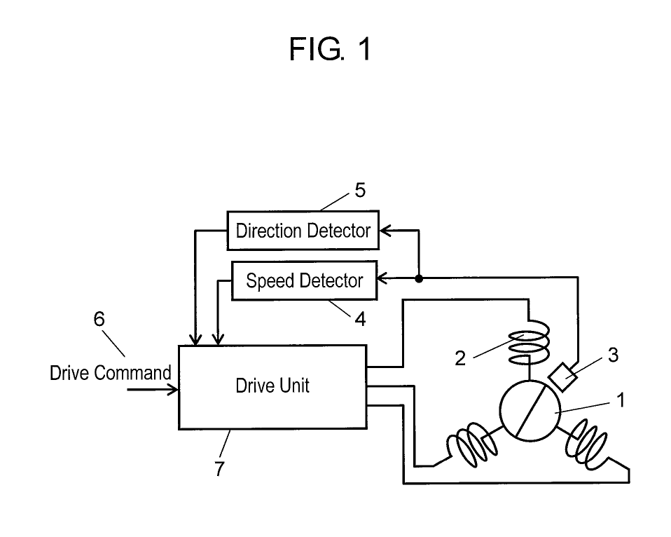

FIG. 1 is a diagram for explaining a configuration that detects a locking state of a motor to protect the motor in a motor drive device according to an exemplary embodiment of the present invention.

As shown in FIG. 1, the motor drive device according to the exemplary embodiment includes at least rotor 1, drive coil 2, rotor position detector 3, speed detector 4, direction detector 5, and drive unit 7 that drives a motor. Rotor position detector 3 includes a rotation sensor such as a hall IC. Speed detector 4 converts position information of rotor 1 detected by rotor position detector 3 into speed information. Direction detector 5 converts position information of rotor 1 detected by rotor position detector 3 into rotating direction information. Drive unit 7 receives drive command 6 to the motor and outputs a drive output such as a drive voltage or a drive current to the motor. The motor is rotationally driven by the drive output outputted from drive unit 7.

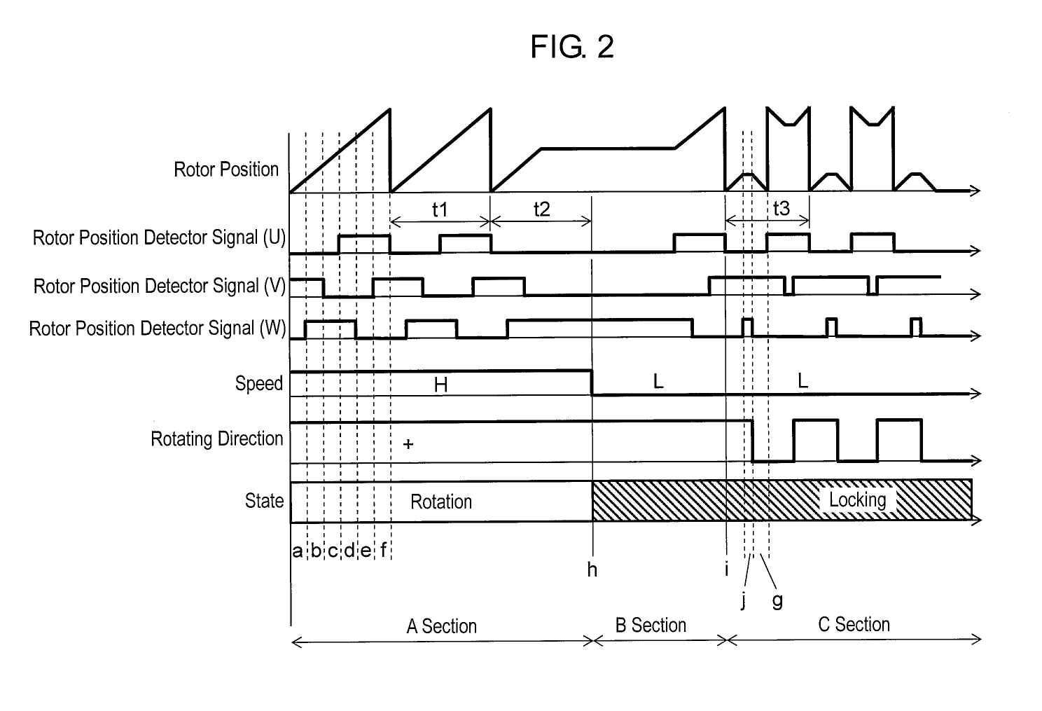

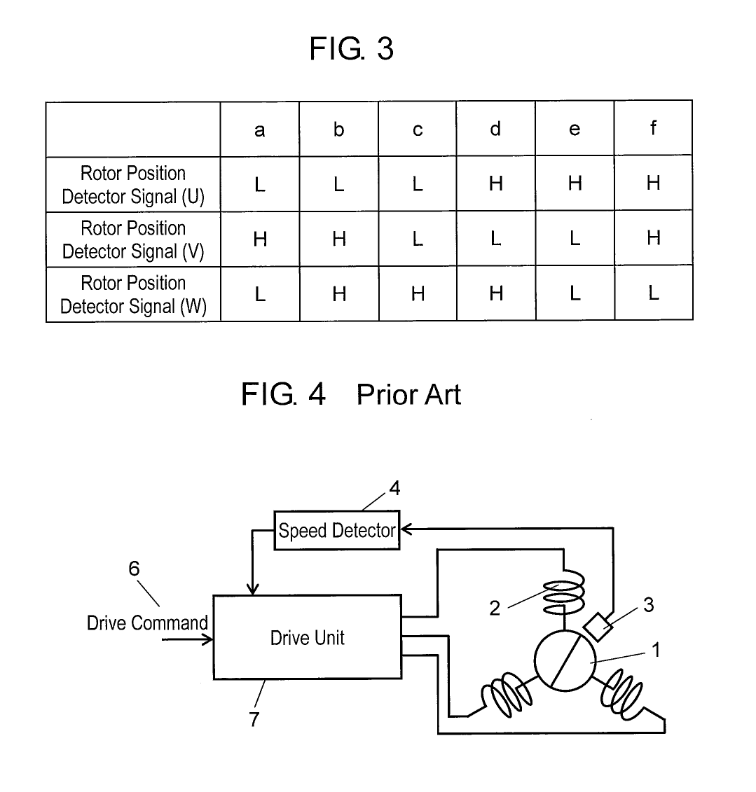

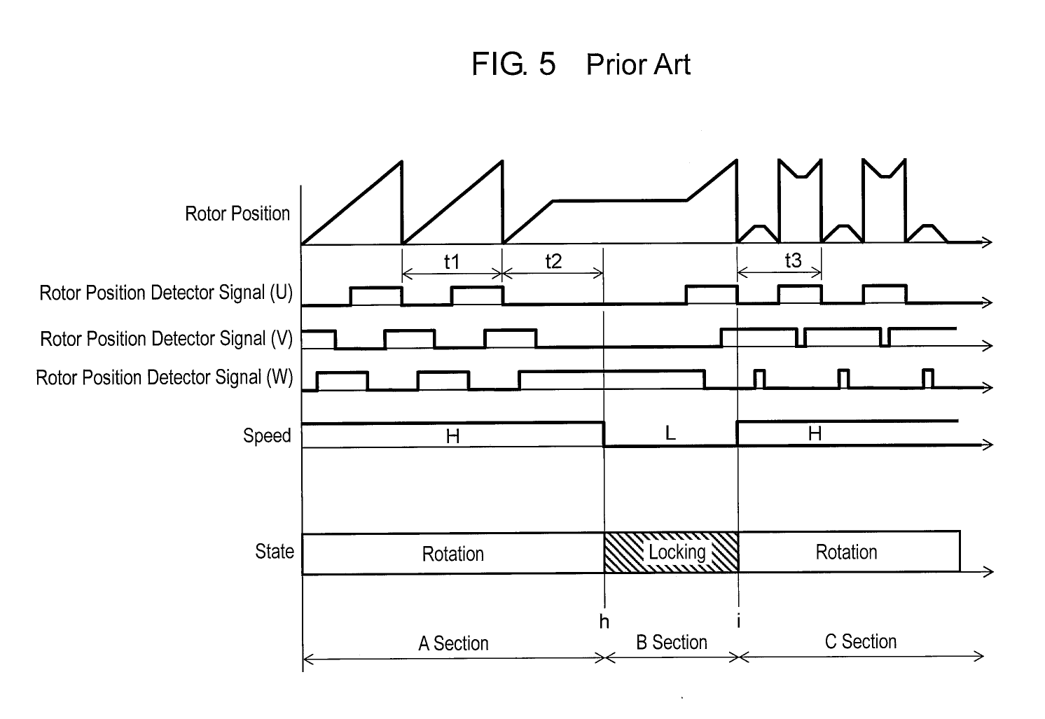

A motor drive device according to the exemplary embodiment of the present invention will be described below with reference to FIG. 2 and FIG. 3 in addition to FIG. 1.

FIG. 2 is a diagram for explaining an operation of detecting a locking state of a motor to protect the motor in the motor drive device according to the exemplary embodiment of the present invention. FIG. 3 is a diagram showing logics of rotor position detector signals (U), (V), and (W) when the motor rotates in a forward direction in the motor drive device.

As shown in FIG. 1, when drive command 6 is inputted to drive unit 7, drive unit 7 turns on a drive output to energize drive coil 2 of the motor. In this manner, rotor 1 of the motor rotates. At this time, rotor 1 is equipped with a magnet. An NS magnetic pole of the magnet of rotor 1 is detected by rotor position detectors 3 that includes, for example, hall elements or hall ICs arranged at different positions in a phase at an electrical angle of 120°. In this manner, rotor position detector 3 outputs rotor position detector signals (U), (V), and (W) having different phases at an electrical angle of 120°.

As shown in FIG. 2, when rotor 1 rotates once, rotor position detector 3 outputs rotor position detector signal (U) as one pulse.

At this time, when rotor 1 rotates in the same direction, speed detector 4 measures time t1 serving as a time interval between rising edges (period from a rising edge to the next rising edge) of the pulse of rotor position detector signal (U) or between falling edges (period from a falling edge to the next falling edge). Based on the measured time t1, speed detector 4 determines a state in which the motor is being rotated (speed information is H). In this manner, the drive output of drive unit 7 is turned on, and, in an A section in FIG. 2, drive outputs such as a drive current and a drive voltage are continuously outputted to drive coil 2 of the motor.

As indicated by a B section in FIG. 2, when rotor 1 is in a locking state, until locking detection time t2 has elapsed, for example, a rising edge or a falling edge of the pulse of, for example, rotor position detector signal (U) is not detected. Thus, speed detector 4 determines that rotor 1 of the motor is in a locking state (speed information is L) and turns off the drive output of drive unit 7.

At this time, as shown in FIG. 3, when the motor rotates in a forward direction, rotor position detector 3, when one rotation of rotor 1 is equally divided by 6 into, for example, an a period to an f period, outputs the logics of H or L rotor position detector signals (U), (V), and (W) in the order of the a period to the f period.

On the other hand, as indicated by a C section in FIG. 2, when the rotor, in a time interval corresponding to time t3, cannot rotate in a forward direction due to a foreign matter having an elastic force such as a branch described above, rotor 1 repeats a forward rotation and a backward rotation due to the elastic force of the branch regardless of rotation control in a predetermined direction. At this time, in the C section in which rotor 1 repeats a forward rotation and a backward rotation in FIG. 2, when a j period corresponding to the b period changes into a g period corresponding to the c period, the logics of rotor detector signals (U), (V), and (W) are not given by (L, L, H) in the c period in a forward rotation state but are given by (L, H, L) as in the g period in FIG. 2. As a result, the logics of rotor detector signals (U), (V), and (W) are different from the logics obtained in the forward rotation state, direction detector 5 shown in FIG. 1 detects that a rotating direction of rotor 1 changes, for example, in a reverse direction.

That is, during measurement of time t3 serving as a time interval from a rising edge to the next rising edge or a falling edge to the next falling edge of a pulse of rotor position detector signal (U), when the reverse rotation of rotor 1 described above is detected, it is determined that speed information measured in time t3 does not reflect an actual speed, and speed detector 4 recognizes the speed information as zero (L).

As described above, according to the exemplary embodiment, under a first condition in which rotor 1 is set in a locking state first, in locking detection time t2, a pulse of a rotor position detector signal is not inputted, the speed information is recognized as zero (L). Under a second condition in which, when rotor 1 repeats a forward rotation and a backward rotation in a locking state, in a period for measuring a time from a rising edge to the next rising edge or a falling edge to the next falling edge of a pulse of a rotor position detector signal, the direction detector detects a change (reverse rotation) of rotating directions of the motor, the speed information is recognized as zero (L). When any one of the first condition and the second condition is established, it is determined that the motor is in a locking state, the drive output of drive unit 7 is turned off to perform locking protection of the motor. In this manner, the motor can be prevented from being broken down, and a motor drive device having excellent reliability and excellent safety can be realized.

### INDUSTRIAL APPLICABILITY

The present invention can be applied to a broad range of a field of an industrial motor, a home electric appliance motor, and the like as a motor drive device that protects a locking state of a motor.

### REFERENCE MARKS IN THE DRAWINGS

1 rotor

2 drive coil

3 rotor position detector

4 speed detector

5 direction detector

6 drive command

7 drive unit

1. A motor drive device comprising:
a motor having a rotor and a drive coil;
a rotor position detector that detects position information of the rotor;
a speed detector that converts the position information into speed information;
a direction detector that converts the position information into rotating direction information; and
a drive unit that drives the motor,
wherein, in a state in which a drive command is inputted to the drive unit and the motor is driven, the motor drive device determines that the motor is locked and turns off a drive output of the drive unit upon detection of any one of a case where a pulse of a rotor position detector signal is not inputted from the rotor position detector into the speed detector and another case where a change of rotating direction of the motor is detected by the direction detector during measurement of a time interval between rising edges or between falling edges of the pulse of the rotor position detector signal from the rotor position detector in a state in which the rotor repeats a forward rotation and a backward rotation in a condition that the rotor is locked.
